(19) United States
(12) Patent Application Publication
(10) Pub. No.: US 2008/0244448 A1
(43) Pub. Date: Oct. 2, 2008

(54) GENERATION OF MENU PRESENTATION RELATIVE TO A GIVEN MENU ORIENTATION

(76) Inventors: Katharina Goering, Karlsruhe (DE); Markus Latzina, Wiesenbach (DE)

Correspondence Address: SCHWEGMAN, LUNDBERG & WOESSNER/SAP, P.O. BOX 2938, MINNEAPOLIS, MN, 55402, US

(21) Appl. No.: 11/835,311

(22) Filed: Aug. 7, 2007

Related U.S. Application Data
(60) Provisional application No. 60/921,213, filed on Apr. 1, 2007.

(51) Int. Cl. G06F 3/048

(52) U.S. Cl. 715/810

(57) ABSTRACT

Methods are disclosed for a computational machine presentation including an origination point for a user, re-arranging a first selectable target more likely to be selected first, to a presentation nearer the origination point. The presentation format persists for any given user across a variety of computational machines, thus minimizing the effort for a given user in terms of cross computational-machine transfer and in terms of an on the average shortened navigational distance for any of the computational machines. The persistent format is consistent for cross computational-machine transfer, and this consistency coincides with a systematic decrease in navigational distance.

### CLAIM OF PRIORITY

The present patent application claims the priority benefit of the filing date of U.S. provisional application No. 60/921,213 filed Apr. 1, 2007, the entire content of which is incorporated herein by reference.

### TECHNICAL FIELD

This disclosure relates generally to menu presentation generation for computational machines to facilitate navigation during use of an application.

### COPYRIGHT NOTICE/PERMISSION

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever. The following notice applies to the software and data as described below and in the drawing hereto: Copyright ©2007, SAP, AG, All Rights Reserved.

### BACKGROUND

Users of an application can often access the application under different contexts. For example a user can access an application by using a desktop platform, but at a different occasion, may access the same application while using a mobile platform such as a handheld computational machine, which may cause a difficulty for the user.

The menu method of accessing the application can differ significantly between the platforms, and indeed, can even differ among the first two, and a third platform such as an audio-only platform.

### DESCRIPTION OF DRAWINGS

The disclosure is illustrated by way of example and not limited to the figures of the accompanying drawings, in which like references may indicate similar elements and in which:

FIG. 1 illustrates a mapping between a conventional navigational list and a navigational list according to an embodiment.

FIG. 2 illustrates various presentations for migrating across different hardware platforms according to an embodiment.

FIG. 3 illustrates a software platform for the generation of a menu presentation relative to a given menu orientation according to an embodiment.

FIG. 4 illustrates a time-dependent navigational tool for a radiant-energy menu presentation according to an embodiment.

FIG. 5 illustrates a hand-held platform for accessing any of the menu presentation embodiments.

FIG. 6 illustrates a hand-held platform for accessing any of the menu presentation embodiments.

FIG. 7 illustrates a hand-held platform for accessing any of the menu presentation embodiments.

FIG. 8 is a diagram of a method for presenting a navigational control record of a browsing session according to an example embodiment of the disclosure.

FIG. 9 is a block diagram of a machine in the illustrative form of a computer system within which a set of instructions, for causing the machine to perform any one or more of the methodologies discussed herein, may be executed.

FIG. 10 is a diagram of an architecture according to various embodiments.

FIG. 11 displays two different conventional presentations that can occur between two platforms that present the same application.

### DETAILED DESCRIPTION

The following description contains examples and embodiments that are not limiting in scope. In the following description, for purposes of explanation, numerous specific details are set forth in order to provide a thorough understanding of an embodiment of the present disclosure. It will be evident, however, to one skilled in the art that the present disclosure may be practiced without these specific details.

A desktop platform may have an abundance of visual/graphical display area to present a menu with useful navigational targets, but a handheld platform will likely have comparatively limited visual/graphical display area to present the same navigational targets.

With a visual/graphical presentation for example, menu presentations can have a top-accessible origination point with a menu that opens downwardly, a bottom-accessible origination point with a menu that opens upwardly, or even a sideways-opening menu, among others. With a visual/graphical presentation, these differing presentations can occur even with a single standard software package.

A difficulty for the user can arise in the hand-held environment, such as a delivery worker who is returning to his vehicle and at the same time accessing an application with his hand-held platform while walking along a busy thoroughfare. The worker desires to focus his viewing upon traffic, both vehicular and pedestrian, but at the same time access the application within the hand-held platform.

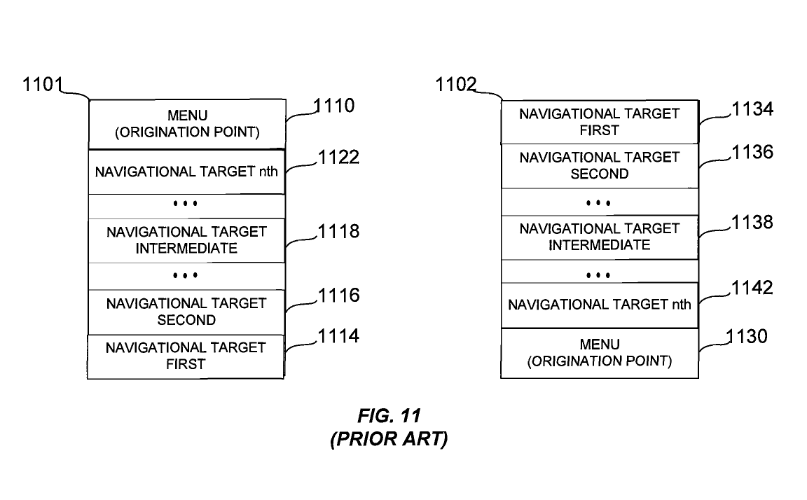

FIG. 11 displays two different conventional presentations that can occur between two platforms that present the same application.

A top-down menu presentation 1101 includes the origination point 1110 such as a menu bar. It may include a first navigational target 1114 that represents a data-access location (DAL) that was first accessed. Several other navigational targets are depicted, such as a second navigational target 1116 that represents a DAL, an intermediate navigational target 1118 that represents a DAL, and a last navigational target 1122 that represents a DAL. A difficulty for a user such as a delivery worker who is accessing the application from a hand-held platform and who may be distracted by traffic, is that he may want to access the DAL represented by the first navigational target 1114, but he may be positioned starting at the origination point 1110 in the menu. Consequently, the delivery worker may have to push a navigational button several times to reach the DAL represented by the first navigational target 1114, which may require diverting his eyes significantly long from observing traffic.

A similar problem exists with a bottom-up menu presentation 1102 where the user reaches the desired DAL by visually scanning the menu display. The same software may be used for the presentation 1101, but the user has migrated to a different hardware platform. The presentation 1102 includes the origination point 1130 such as a menu bar. It also includes a first navigational target 1134 that represents a DAL that was first accessed. Similarly to the top-down menu presentation 1101, the bottom-up menu presentation 1102 may display several other navigational targets, such as a second navigational target 1136 that represents a DAL, an intermediate navigational target 1138 that represents a DAL, and a last navigational target 1142 that represents the last-accessed DAL. The difficulty for a delivery worker is similar to that depicted with the top-down menu presentation 1101 as for this bottom-up menu presentation 1102. The delivery worker may want to access the DAL represented by the first navigational target 1134, but he may be positioned in the menu at the origination point 1130. Consequently, the delivery worker may have to push a navigational button several times to reach the DAL represented by the first navigational target 1134, which may require diverting his eyes significantly long from observing traffic if the navigation tasks requires him to visually track the results of his navigational behavior.

Terminology

The following terminology is exemplary but not limiting. A “selectable target” is synonymous with a menu element that can be selected by a user. A “data-access location” (DAL) is accessed by using a selectable target.

A “navigational target” is an accessible target on a presentation of a menu that directs the user to a different location within a given application, or to a different application.

An “object target” is a selectable target on a presentation of a menu that can import or export a file, or a data structure that is stored in memory.

In the various embodiments disclosed herein, there are visual menu presentations, audio menu presentations, tactile menu presentations, and combinations thereof.

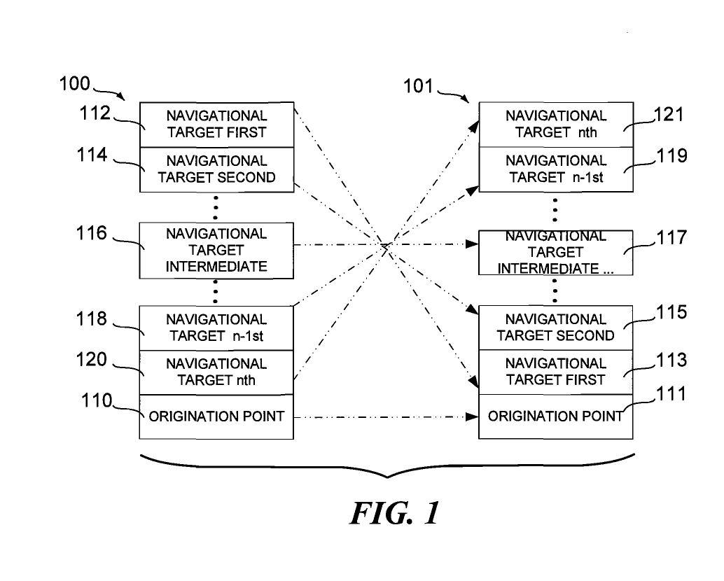

FIG. 1 illustrates a comparison between a conventional navigational list and a navigational list that is generated as a menu presentation according to an embodiment. A bottom-up menu presentation 100, as a conventional menu orientation, includes the origination point 110 such as a menu bar. It may also include the first navigational target 112 that represents a data-access location that was first accessed. The bottom-up menu presentation 100 may display several other navigational targets, such as a second navigational target 114 that represents a DAL, an intermediate navigational target 116 that represents a DAL, and the second to last navigational target 118 that represents a DAL as well as the last navigational target 120 that represents the last-accessed DAL. Again, the difficulty is that a user may want to access the DAL represented by the first navigational target 112, but the user may be positioned in the menu at the origination point 110 at the onset of starting to navigate to DAL 112. Consequently, the user may have to push a navigational button several times to reach the DAL represented by the first navigational target 112, which may require diverting his eyes significantly long from observing traffic in order to ensure that he reaches the desired DAL by visually scanning the menu display.

The bottom-up menu presentation 101 for a given computational machine, according to an embodiment, represents a transformation of the bottom-up menu presentation 100, such that it is a generation of a menu presentation relative to the given menu presentation 101. This embodiment includes the origination point 111 such as a menu bar. It may also include the first navigational target 113 that represents a DAL that was first accessed. The bottom-up menu presentation 101 may display several other navigational targets, such as a second navigational target 115 that represents a DAL, an intermediate navigational target 117 that represents a DAL, and the second to last navigational target 119 that represents a DAL as well as the last navigational target 121 that represents the last-accessed DAL.

Where the user likely wants to navigate from the origination point 111 to the first navigational target 113, only a single, generic command is required such as a single button push, and the first navigational target 113 is accessible accordingly at the onset of starting to navigate to DAL 112 and subsequently reached immediately as a result of the single button push. The computational machine presentation therefore re-arranges the first navigational target 113 in a spatial relationship to a presentation location that is nearer the origination point 111. Consequently, the user need not divert his attention from traffic, but with haptic knowledge of the menu presentation can navigate more easily from the origination point 111 to the first navigational target 113.

The “first navigational target 113” may be a most likely or most frequently accessed navigational target 113 to be first accessed when the user has returned to the platform to access data. The most frequently accessed navigational target 113 may also be referred to as a most frequently visited data-access location. For example, a delivery worker may have a queue of deliveries that are electronically stored in data-access locations, and after delivering to a customer, he accesses the application from a hand-held device, and navigates to the first navigational target 113. Consequently the DAL, accessed at the first navigational target 113, allows the delivery worker to immediately and with a single action, ascertain his next customer in the delivery queue. Further, the single action does not require diversion of his attention. In a method embodiment, the method includes compiling a list of visited data-access locations. In an embodiment, however, a method may further include monitoring a selection likelihood of a first selectable target such as the first navigational target 113 and a second selectable target such as the second navigational target 115, and when the second selectable target becomes more likely to be selected than the first selectable target, the method further includes re-arranging the second selectable target to a presentation nearer the origination point, and re-arranging the first selectable target to a presentation less near the origination point than the second selectable target. In other words, the second selectable target is presented as a prominent selectable target or a most recently visited data-access location. In an embodiment, re-arranging the order of selectable targets may occur consistently for all platforms that may be available for use of the same application.

It can be seen that another method embodiment includes a second selectable target and a third selectable target, the method including, where re-arranging the second selectable target because it is less likely to be selected first, to a presentation nearer the origination point, but re-arranging the third selectable target less likely to be selected second, to a presentation nearer the origination point, but the second selectable target is re-arranged to a presentation nearer the origination point than the third selectable target.

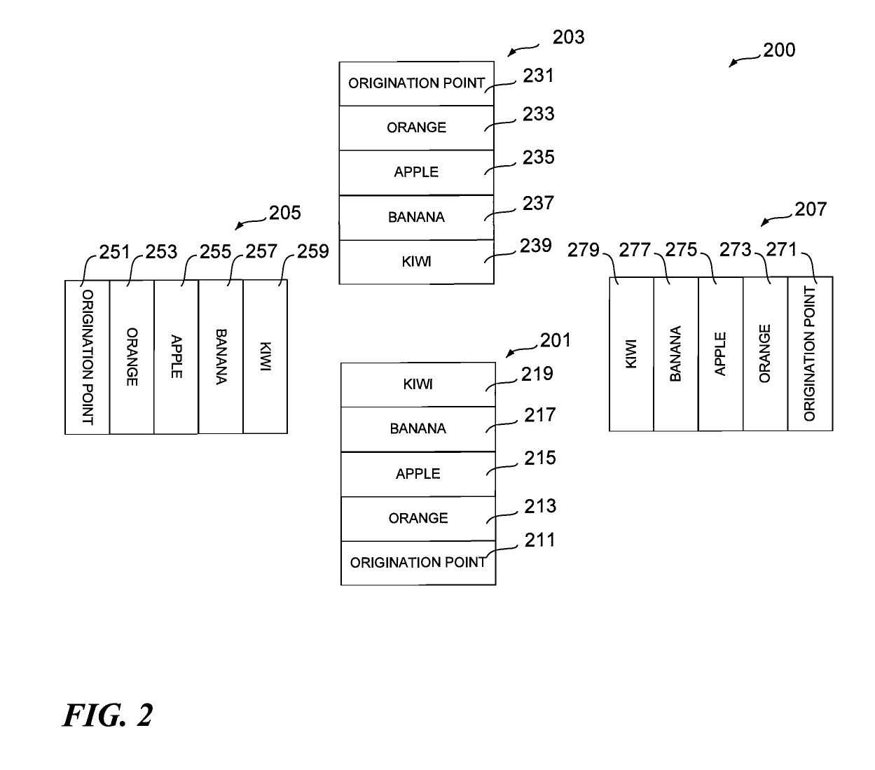

FIG. 2 illustrates various presentations 200 for migrating across different hardware platforms (also referred to as “hardware contexts”), according to an embodiment.

A bottom-up menu presentation 201 shows an origination point 211 and then DALs named ORANGE 213, APPLE 215, BANANA 217, and KIWI 219. These DALs are rearranged according to likelihood of access from the origination point 211, based upon frequency of use, or based upon likelihood of being used next according to an embodiment.

A top-down menu presentation 203 shows an origination point 231 and then DALs named ORANGE 233, APPLE 235, BANANA 237, and KIWI 239. These DALs are rearranged according to likelihood of access from the origination point 231, based upon frequency of use, or based upon likelihood of being used next according to an embodiment. In an embodiment, a user has migrated between two hardware platforms, which display the respective menu presentations, one being bottom-up 201 and the other being top-down 203. Because the presentation style persists between the two hardware platforms, the user experiences an ease of use despite migrating between the two respective hardware platforms.

A left-to-right sideways menu presentation 205 shows an origination point 251 and then DALs named ORANGE 253, APPLE 255, BANANA 257, and KIWI 259. These DALs are rearranged according to likelihood of access from the origination point 251, based upon frequency of use, or based upon likelihood of being used next according to an embodiment. In an embodiment, a user has migrated between two hardware platforms, which display the respective menu presentations, one being bottom-up 201 and the other being left-to right sideways 205. The user experiences an ease of use despite migrating between the two respective hardware platforms.

A right-to-left sideways menu presentation 207 shows an origination point 271 and then DALs named ORANGE 273, APPLE 275, BANANA 277, and KIWI 279. These DALs are rearranged according to likelihood of access from the origination point 271, based upon frequency of use, or based upon likelihood of being used next according to an embodiment. In an embodiment, a user has migrated between two hardware platforms, which display the respective menu presentations, one being bottom-up 201 and the other being right-to-left sideways 207. The user experiences an ease of use despite migrating between the two respective hardware platforms.

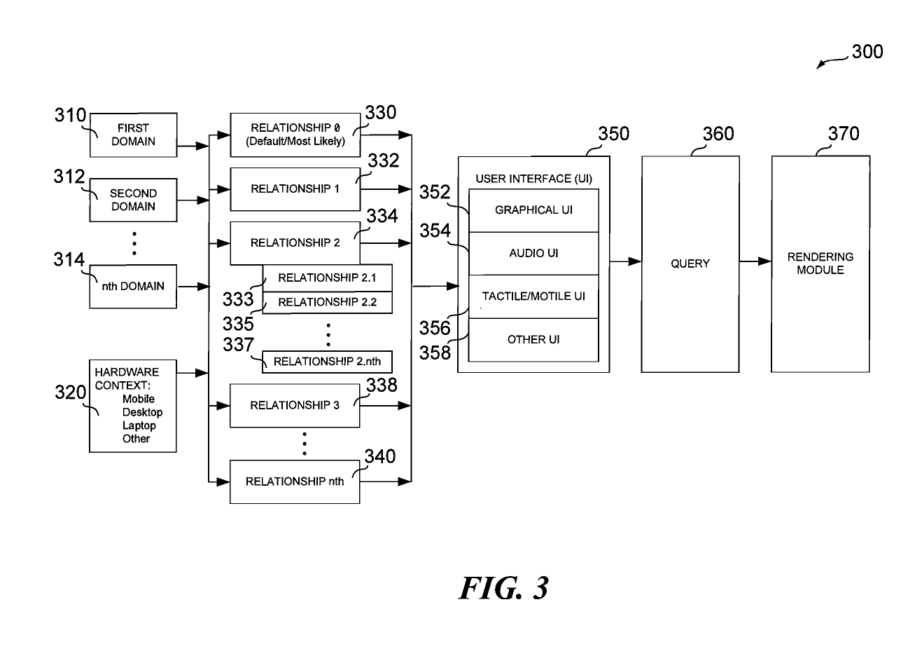

FIG. 3 illustrates a software platform 300 for the generation of a menu presentation relative to a given menu orientation according to an embodiment. In an embodiment, several different domains may be used to access the software platform 300. In an embodiment, several different hardware contexts may be used to access the software platform 300. Specialized hardware contexts may use only a portion of the software platform 300.

In an embodiment, a user may invoke the software platform 300, and a user domain is recognized thereby. In an embodiment a user FIRST DOMAIN 310 represents a recognition capability of the software platform 300. Where a user may migrate between hardware contexts, the user may still access the same data from the user FIRST DOMAIN 310, although he may be using a different hardware context. Other domains are represented, including a user SECOND DOMAIN 312 and so on until a user n^{th} DOMAIN 314. In an embodiment a given user domain may be an internet-based source through which a user is operating. In an embodiment a given user domain may be a telephonic communications-based source through which a user is operating.

A user may also invoke the software platform 300 by a subsequent hardware context 320, such as a mobile platform (mobile machine), a desktop platform (desktop machine), a laptop platform (laptop machine), or other platforms.

In an embodiment, the user domain and the hardware platform are recognized by the software platform 300, and the software platform 300 adapts to the combination for a configuration that is useful for the specific user, but that may adapt for an alternative user.

The software platform 300 also recognizes a relationship, in concert with the given domain and hardware context. In an embodiment, a RELATIONSHIP 0^{th} 330 is recognized such as a specific customer with specific needs. In an embodiment, the RELATIONSHIP 0^{th} 330 represents a default relationship, such as a most likely relationship for a given configuration of the software platform 300. In an example embodiment of the delivery person, the relationship may invoke a specialized subset of a given application, such that the specialized subset has been configured to meet the most useful needs of the delivery person as the user of the software platform 300. At another time, the delivery person may invoke the software platform 300 that requires a different relationship. For example in the field, the delivery person RELATIONSHIP 0^{th} 330 maybe useful, but in a reporting meeting such as a headquarters, a different relationship is more useful.

In an example embodiment, the software platform 300 is configured for private individual use such as a wireless telephone user. The RELATIONSHIP 1^{st} 332 may be configured for the wireless telephone user, and the wireless telephone user may be accessing an email attachment that requires the execution of a software program such as a word processor. Accordingly the RELATIONSHIP 1^{st} 332 may allow the wireless telephone user to have an efficient session while opening and navigating through the word processor. For example, where the RELATIONSHIP 1^{ST} 332 is a wireless telephone network, a user such as a delivery person may migrate from a wireless first hardware context to a desktop (subsequent) hardware context 320 and continue working on a task. Accordingly, the bottom-up presentation may be emulated within the desktop (subsequent) hardware context 320 that matches the presentation that was in the wireless telephone first hardware context 320.

Other relationships are also depicted, including a RELATIONSHIP 2^{nd} 334, a RELATIONSHIP 3^{rd} 338, and so on until a RELATIONSHIP n^{th} 340. In an embodiment, the various relationships may represent various different customers who have distinct and specific customer needs the software platform may be designed to handle.

In an embodiment, the RELATIONSHIP 2^{nd} 334 depicts sub-relationships, including a RELATIONSHIP 2.1^{st} 333, a RELATIONSHIP 2.2^{nd} 335, and so on until a RELATIONSHIP 2.n^{th} 337. In an embodiment, the various sub-relationships may represent various different subdivisions within a customer, where each subdivision has distinct and specific customer needs that the software platform 300 may be designed to handle.

For example, a delivery person using, e.g., a wireless FIRST DOMAIN 310 and a mobile first hardware context 320, may have a selected menu presentation such as bottom-up. The computational machine presentation therefore re-arranges a first navigational target to a presentation location that is nearer the origination point. In other words, the computational machine presentation therefore re-arranges a first navigational target to a presentation location that makes it a prominent navigational target. An associate of the delivery person using, e.g., a wide-area network (WAN) user SECOND DOMAIN 312 and a laptop (subsequent) hardware context 320, may observe the menu presentation, but it may be identical to the presentation observable by the delivery person, e.g., bottom-up, or it may be a presentation that is different. Further, another associate of the delivery person using, e.g. an internet n^{th} DOMAIN 314 and a desktop (subsequent) hardware context 3, may observe the menu presentation, but it may be identical to the presentation observable by the delivery person, e.g., bottom-up, or it may be a presentation that is different. In other words, the computational machine presentation therefore re-arranges the first navigational target to a presentation location that is not nearer the origination point, rather, it may be re-arranged in a manner such as is depicted at 100 in FIG. 1.

In an embodiment, the various sub-relationships may represent various different customer types that are not necessarily related as business entities, but where each subdivision has distinct and specific customer needs for that given customer type that the software platform 300 may be designed to handle.

The software platform 300 recognizes a user domain, a hardware context, a relationship, and a user interface 350. The user interface 350 can vary even with a single user, as he may migrate among different hardware platforms, but may access the same application from the various different hardware platforms. Examples of various user interfaces (UIs) include a graphical UI 352, an audio UI 354, a tactile/motile UI 356, or an other UI 358. In an embodiment, any combination of the given UIs may be used to assist the user. In an embodiment, a user migrates between a first hardware platform and a second hardware platform, and retains the same UI presentation to the various illustrated embodiments depicted in FIG. 2

In an embodiment, a transformation of a bottom-up menu presentation for a given computational machine, such as the menu presentation 101 depicted in FIG. 1, is carried out with a graphic UI 352. In an embodiment, however, a visually impaired user may require a different UI. For example, a delivery person may be negotiating movement through vehicular and pedestrian traffic, and an audio UI 354 interface is more useful such that the delivery person may receive auditory feedback and need not divert his vision away from the traffic. The audio UI 354, however, allows the delivery person to immediately access, e.g., the first navigational target 113, and an audio signal informs the delivery person that the requested DAL has been accessed. In an embodiment with the delivery person, the delivery person may have tactile-sequential access to the UI 356, but with a button push, an audio signal informs the delivery person that the requested DAL has been accessed by use of the audio UI 354. Consequently, a combination graphical UI 352, audio UI 354, and tactile/motile UI 356 has been employed to assist the user.

In an embodiment, a user with visually impaired eyesight may use the audio UI 354 with neither graphical, not tactile/motile assistance. In this embodiment, the user makes a single audible command, which the audio UI 354 recognizes, and in an example embodiment, the audible command equivalent to “NAVIGATIONAL TARGET FIRST” but a simplified command such as “push”, which emulates single button push of a tactile/motile UI.

After the software platform 300 recognizes the domain, the hardware context, the relationship and sub-relationship if necessary, and the specific user interface, the software platform 300 accepts a query 360. A query 360 may be a button push, an audible command, a screen position selection on a graphical UI, or an other query.

Thereafter, a rendering module 370 gives communication feedback through the hardware context 320 to the user. Accordingly, the computational machine presentation may be customized by re-arranging a first selectable target more likely to be selected first, to a presentation nearer the origination point. The software platform therefore allows a user to migrate between hardware contexts 320, to migrate between domains, and even migrate between relationships, such that the user interface may be re-arranged to simplify or reduce the number and complexity of commands needed to efficiently access the given software.

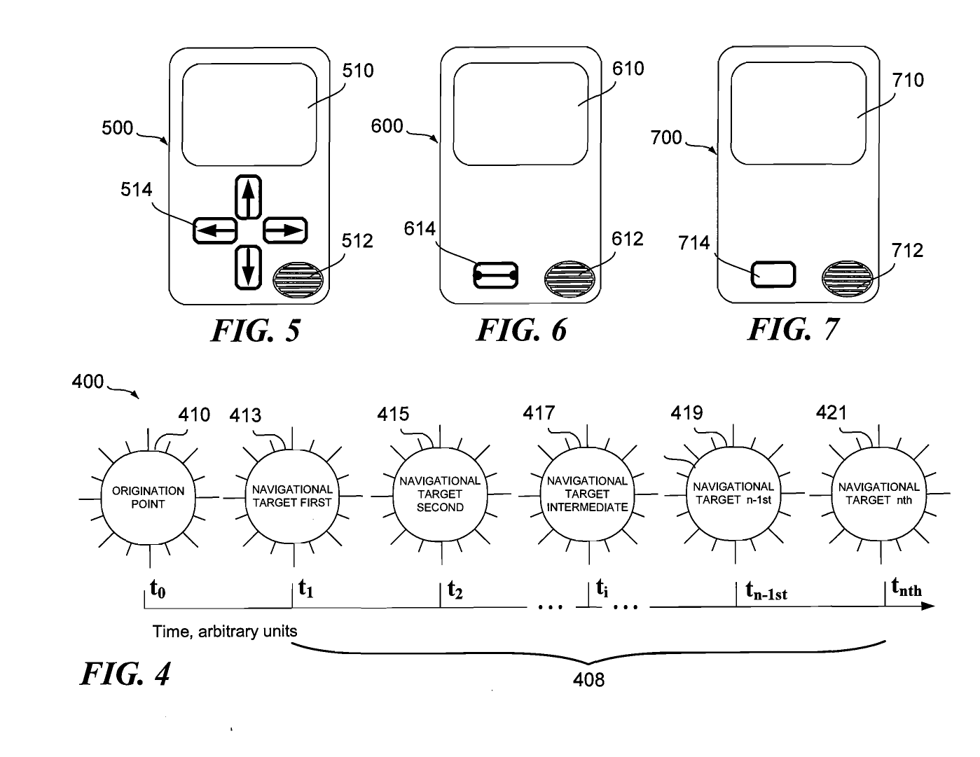

FIG. 4 illustrates a time-dependent navigational tool for a radiant-energy menu computational machine presentation 400 according to an embodiment. This embodiment includes an origination point 410. The origination point 410 is depicted with radiant-energy lines, as it represents an audio signal for example. The origination point 410 may also represent a visual presentation such as a single display at a given time. A timeline 408 represents a zeroth time for the origination point 410, and several other times up to an n^{th} time (tₙₜₕ) In an embodiment, a user invokes the origination point 410 by an audible command, and a first navigational target 413 is executed by an audio reply. When the user desires to access the DAL represented by the first navigational target 413, the user may give a second audible command accordingly.

Should the user, however, choose a different navigational target, several other navigational targets may be broadcast to the user while he waits. FIG. 4 depicts other navigational targets such as a second navigational target 415 that represents a DAL, an intermediate navigational target 417 that represents a DAL, and a second to last navigational target 419 that represents a DAL as well as a last navigational target 421 that represents the last-accessed DAL. This embodiment may be used by the user, for example, where the user is visually impaired. Further according to an embodiment, the user may configure the radiant-energy menu presentation 400 in a given instance where he may be visually distracted by negotiating traffic. At another time, the user may configure a different menu presentation where he may not be visually distracted, but he may have migrated to a different hardware platform.

In an embodiment, the user may want an audio menu computational machine presentation 400, but has tactile access to his hardware context 320 such as a hand-held computing machine. Where the user likely wants to navigate from the origination point 410 to the first navigational target 413, a single command such as a single button push is first required, and the first navigational target 413 is presented. The user then may repeat a button push, or, he may give an audible command to access the DAL represented by the first navigational target 413. Consequently, the user need not divert his attention from traffic, but with audible and haptic knowledge of the menu presentation but will navigate more easily from the origination point 410 to the first navigational target 413 by embracing the audio presentation or the haptic presentation.

FIG. 5 illustrates a hand-held platform 500 for accessing any of the menu presentation embodiments. The hand-held platform 500 can be a computational machine that includes a graphical UI 510, an audio UI 512, and a tactile/motile UI 514. In an embodiment, a software platform such as the software platform 300 or a subset thereof, recognizes the hand-held platform 500 as an appropriate hardware context. The software platform may also recognize a domain, a relationship, and based upon a given likely user, a selected combination of UIs such as some of the UIs 350 depicted in FIG. 3. The tactile/motile UI 514 is represented as four directional navigation buttons. It can be seen that a given user with the hand-held platform 500, may access a given application by several combinations, including presenting the most likely to be accessed DAL first in time or closest to an origination point.

FIG. 6 illustrates a hand-held platform 600 for accessing any of the menu presentation embodiments. The hand-held platform 600 includes a graphical UI 610, an audio UI 612, and a tactile/motile UI 614. In an embodiment, a software platform such as the software platform 300 or a subset thereof, recognizes the hand-held platform 600 as an appropriate hardware context. The software platform may also recognize a domain, a relationship, and based upon a given likely user, a selected combination of UIs such as some of the UIs 250 depicted in FIG. 3. The tactile/motile UI 614 is represented as a toggle navigation button. It can be seen that a given user with the hand-held platform 600, may access a given application by several combinations, including presenting the most likely to be accessed DAL first in time or closest to an origination point, or by displaying the same UI presentation because the user may have migrated to a different hardware platform.

In an embodiment, the software platform may be web-based accessible, and the specific UI configuration may be programmable into the hardware context, depending upon the specific user profile etc., and the tasks the user will be or is undertaking.

FIG. 7 illustrates a hand-held platform 700 for accessing any of the menu presentation embodiments. The hand-held platform 700 includes a graphical UI 710, an audio UI 712, and a tactile/motile UI 714. In an embodiment, a software platform such as the software platform 300 or a subset thereof, recognizes the hand-held platform 700 as an appropriate hardware context. The software platform may also recognize a domain, a relationship, and based upon a given likely user, a selected combination of UIs such as some of the UIs 350 depicted in FIG. 3. The tactile/motile UI 714 is represented as a single navigation button. With a single navigation button, and where the software platform assists the user, the hand-held platform 600, may be used to access a given application by several combinations, including presenting the most likely to be accessed DAL first in time or closest to an origination point. Further with any of the input/output functionalities, a user may wrap around a presented menu if a given navigational target is missed.

Accordingly, a first hand-held platform may be a Pocket PC®, and a second hand-held platform may be a Blackberry®. In other words, a first computation computational machine and a second computational machine belong to a single user, and the user migrates from one to the other, but requires further computation on the second, as a continuing session from the first. Consequently, re-arranging the first selectable target is derived from instructions for the first computational machine. In the first computational machine, the first selectable target is originally presented nearer the origination point.

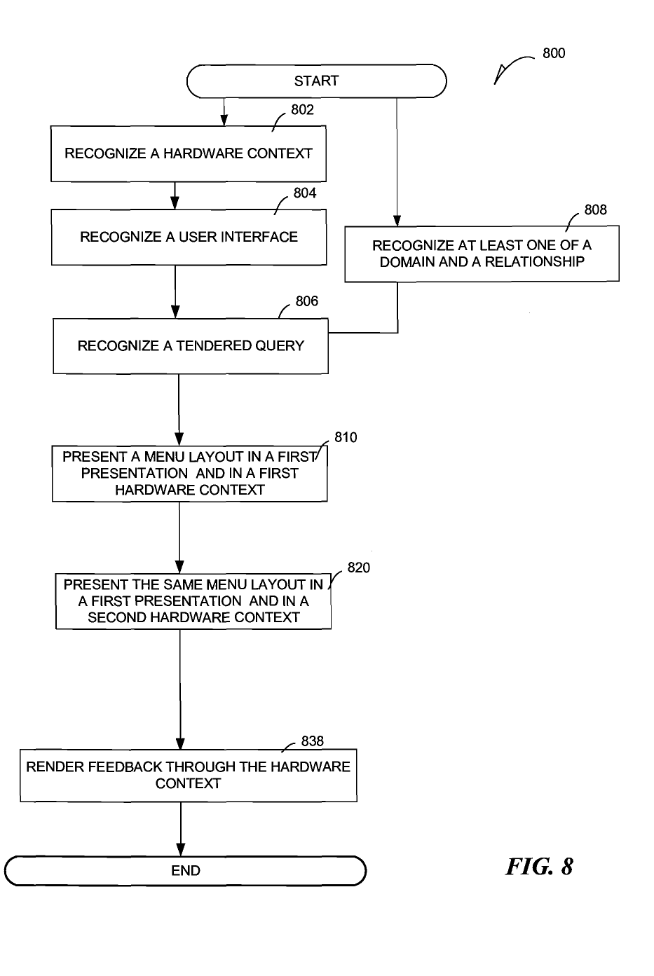

FIG. 8 is a diagram of a method 800 for presenting a navigational control record of a browsing session according to an example embodiment of the disclosure.

At 802, the method includes recognizing a hardware context.

At 804, the method includes recognizing a user interface.

At 806, the method includes recognizing a query.

At 808, the method includes at least one of recognizing a domain and a relationship.

At 810, the method includes presenting a menu layout in a first presentation in a first hardware context.

At 820, the method includes presenting the same menu layout in the first presentation in a second hardware context.

At 830, the method includes rendering feedback through the second hardware context.

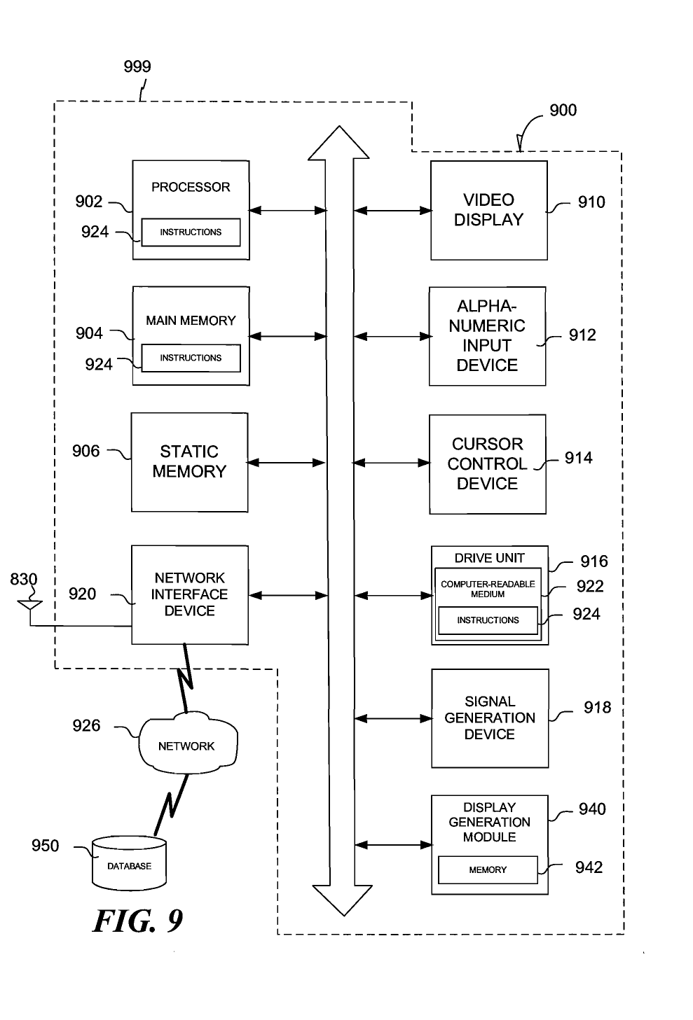

FIG. 9 is a block diagram of a computing machine 999 in the example form of a computer system 900 within which a set of instructions, for causing the machine 999 to perform any one or more of the methodologies discussed herein, may be executed. For example, computer instructions include generating a computational machine presentation using an origination point for a user and re-arranging a first selectable target more likely to be selected first, to a presentation nearer the origination point. In an embodiment, computer instructions recognize a user who has migrated between a first hardware platform and a second hardware platform, and the instructions are to preserve the UI configuration the user had in the first hardware platform.

In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 900 includes a processor 902 (e.g., a central processing unit (CPU), a graphics processing unit (GPU) or both), a main memory 904 and a static memory 906 that communicate with each other via a bus 908. The computer system 900 may further include a video display unit 910 (e.g., a liquid crystal display (LCD) or a cathode ray tube (CRT)). The computer system 900 also includes an alphanumeric input device 912 (e.g., a keyboard), a user interface (UI) navigation device 914 (e.g., a mouse), a disk drive unit 916, a signal generation device 918 (e.g., a speaker) and a network interface device 920.

The disk drive unit 916 includes a machine-readable medium 922 on which is stored one or more sets of instructions and data structures (e.g., software 924) embodying or utilized by any one or more of the methodologies or functions described herein. The instructions 924 may also reside, completely or at least partially, within the main memory 904 and/or within the processor 902 during execution thereof by the computer system 900, the main memory 904 and the processor 902 also constituting machine-readable media.

The instructions 924 may further be transmitted or received over a network 926 via the network interface device 920 utilizing any one of a number of well-known transfer protocols (e.g., hyper-text transfer protocol, HTTP). In various embodiments, the machine 999 is a wireless device and includes an antenna 930 that communicatively couples the machine 999 to the network 926 or other communication devices. Other devices may include other machines similar to the machine 999, wherein the machine 999 and the other machines operate in an ad-hoc mode of communicator with one and other.

In various embodiments, the network 926 couples the machine 999 to a database 950. In various embodiments, the database 950 includes data that may be displayed with assistance of the machine 999 by using the video display 910.

While the machine-readable medium 922 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the disclosed embodiments, or that is capable of storing, encoding or carrying data structures utilized by or associated with such a set of instructions. The term “machine-readable medium” shall accordingly be taken to include, but not be limited to, solid-state memories, optical and magnetic media, and carrier wave signals. The disclosed embodiments can be implemented in digital electronic circuitry, or in computer hardware, firmware, software, or in combinations of them. The disclosed embodiments can be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

In various embodiments, the machine 999 includes a display generation module 940. In various embodiments, the display generation module 940 is a software application. In various embodiments, the display generation module 940 includes hardware which may include a memory storage device 942, which may include software stored on the memory storage device. In various embodiments, display generation module 940 is operable to generate commands to format data to be displayed on the video display 910 according to the various methods described herein.

The embodiments can be implemented in digital electronic circuitry, or in computer hardware, firmware, software, or in combinations of them. The disclosed embodiments can be implemented as a computer program product, for example, a computer program tangibly embodied in an information carrier, for example, in a machine-readable storage device or in a propagated signal, for execution by, or to control the operation of, data processing apparatus, for example, a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method operations of any disclosed embodiments and their equivalents can be performed by one or more programmable processors executing a computer program to perform functions of the disclosed embodiments by operating on input data and generating output. Method operations can also be performed by, and apparatus of the disclosed embodiments can be implemented as, special purpose logic circuitry, for example, an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, for example, EPROM, EEPROM, and flash memory devices; magnetic disks, for example, internal hard disks or removable disks; magneto-optical disks; and CD-ROM and DVD-ROM disks. The processor and the memory can be supplemented by, or incorporated in special purpose logic circuitry.

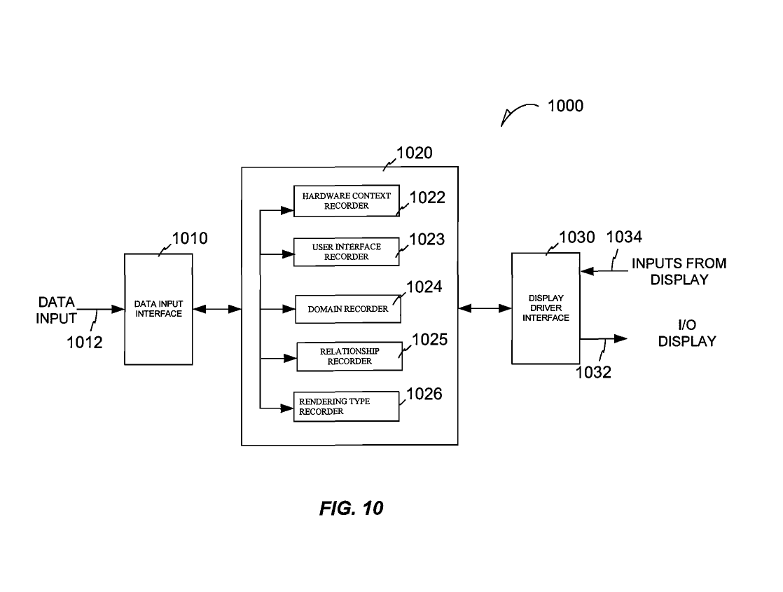

FIG. 10 is a diagram of an architecture 1000 according to various embodiments for generating a computational machine presentation. In various embodiments, the architecture 1000 includes a module 1020. The module 1020 may be software, hardware, or may be a combination of software and hardware. In various embodiments, module 1020 may include software stored as instructions, for example the instructions 924 associated with the processor 902 in FIG. 9. In various embodiments, the module 1020 may be the display generation module 940 as shown in FIG. 9. In various embodiments, the module 1020 includes instructions that may be stored in more than one place within the architecture 1000. In various embodiments, the module 1020 includes one or more of the following: hardware context recorder 1022, user interface recorder 1023, domain recorder 1024, relationship recorder 1025, and rendering type recorder 1026. In various embodiments, the module 1020 is coupled to the data input interface 1010. In various embodiments, the data input interface 1010 is operable to receive input data 1012 and to provide the module 1020 with the data, such as data derived from a user's navigation through an application.

In various embodiments, module 1020 is coupled to a display driver interface 1030. In various embodiments, the display driver interface 1030 interfaces with the module 1020 to receive data provided by the module 1020 and provides an output 1032 to control a display. Various embodiments of apparatus, methods, and system have been described herein. Various embodiments include an apparatus comprising a display to provide a visual representation of a generation of a menu presentation relative to a given menu orientation.

Various embodiments include a system comprising a wireless device including an antenna to communicatively couple the wireless devices to one or more other devices, and the wireless device including a display and a display generation module couple to the display, the display generation module to generate commands to cause the display to provide a presentation generation of a menu presentation relative to a given menu orientation.

Various embodiments include a machine-readable medium embodying instructions that, when executed by a machine, cause the machine to display a generation of a menu presentation relative to a given menu orientation.

The embodiments can be implemented in digital electronic circuitry, or in computer hardware, firmware, software, or in combinations of them. The embodiments can be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method operations of the embodiments can be performed by one or more programmable processors executing a computer program to perform functions of the embodiments by operating on input data and generating output. Method operations can also be performed by, and apparatus of the embodiments can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks such as internal hard disks and removable disks; magneto-optical disks; and CD-ROM and DVD-ROM disks. The processor and the memory can be supplemented by, or incorporated in special purpose logic circuitry.

The embodiments can be implemented in a computing system that includes a back-end component, e.g., as a data server, or that includes a middleware component, e.g., an application server, or that includes a front-end component, e.g., a client computer having a graphical user interface or an Web browser through which a user can interact with an implementation of the embodiments, or any combination of such back-end, middleware, or front-end components. The components of the system can be interconnected by any form or medium of digital data communication, e.g., a communication network. Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

Certain applications or processes are described herein as including a number of modules or mechanisms. A module or a mechanism may be a unit of distinct functionality that can provide information to, and receive information from, other modules. Accordingly, the described modules may be regarded as being communicatively coupled. Modules may also initiate communication with input or output devices, and can operate on a resource (e.g., a collection of information).

Although an embodiment have been described with reference to specific example embodiments, it will be evident that various modifications and changes may be made to these embodiments without departing from the broader spirit and scope of the embodiments. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. Embodiments from one or more drawings may be combined with embodiments as illustrated in one or more different drawings. This Detailed Description, therefore, is not to be taken in a limiting sense, and the scope of various embodiments is defined only by the appended claims, along with the full range of equivalents to which such claims are entitled.

While the foregoing disclosure shows a number of illustrative embodiments, it will be apparent to those skilled in the art that various changes and modifications can be made herein without departing from the scope of the embodiments as defined by the appended claims. Accordingly, the disclosed embodiment are representative of the subject matter which is broadly contemplated by the embodiments, and the scope of the embodiments fully encompasses other embodiments which may become obvious to those skilled in the art, and that the scope of the embodiments is accordingly to be limited by nothing other than the appended claims.

Moreover, ordinarily skilled artisans will appreciate that any illustrative logical blocks, modules, circuits, and process operations described herein may be implemented as electronic hardware, computer software, or combinations of both.

To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the embodiments.

The previous description of the disclosed embodiments is provided to enable any person skilled in the art to make or use the embodiments. Various modifications to these embodiments will be readily apparent to those skilled in the art, and the generic principles defined herein may be applied to other embodiments without departing from the spirit or scope of the embodiments. Thus, the embodiments are not intended to be limited to the embodiments shown herein but are to be accorded the widest scope consistent with the principles and novel features disclosed herein.

The abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims.

In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A method comprising:
in a first computational machine presentation including a first hardware context and including an origination point for a user, re-arranging a first selectable target more likely to be selected first, to a presentation nearer the origination point; and
in a subsequent computational machine presentation and including the origination point for the user, presenting the first selectable target similarly as in the first hardware context.

2. The method of claim 1, wherein the subsequent computational machine presentation includes a subsequent hardware context.

3. The method of claim 1, further including in a subsequent hardware context and including the origination point for the user, presenting to a subsequent user, the first selectable target differently as in the first hardware context.

4. The method of claim 1, wherein the subsequent computational machine presentation includes a subsequent hardware context, the method further including the origination point for the user, presenting the first selectable target differently as in the first hardware context.

5. The method of claim 1, wherein a user first domain is recognized for the first hardware context, and wherein the user first domain is used between the first hardware context and the subsequent hardware context.

6. The method of claim 1, wherein a user first domain is recognized for the first hardware context, and wherein a user second domain is recognized between the first hardware context and the subsequent hardware context.

7. The method of claim 1, further including recognizing a first user relationship in connection with the user domain, the first hardware context and the subsequent hardware context.

8. The method of claim 1, further including:
first recognizing a first user relationship in connection with the user domain, the first hardware context and the subsequent hardware context; and
subsequently recognizing a subsequent user relationship in connection with the user domain, the first hardware context and the subsequent hardware context.

9. A method comprising:
in a presentation for a first computational machine including an origination point for a user, re-arranging a first selectable target more likely to be selected first, to a presentation nearer the origination point; and
in a subsequent presentation for a subsequent computational machine including the origination point for the user, presenting the first selectable target nearer the origination point, and wherein the first computational machine includes a first hardware context and the subsequent computational machine includes a subsequent hardware context that is different from the first hardware context.

10. The method of claim 9, further including a second selectable target, the method including re-arranging a second selectable target less likely to be selected first, to a presentation nearer the origination point, but wherein the first selectable target is re-arranged to a presentation nearer the origination point than the second selectable target.

11. The method of claim 9, further including monitoring selection likelihood of the first selectable target and a second selectable target; and when the second selectable target becomes more likely to be selected than the first selectable target, the method further includes:
re-arranging the second selectable target to a presentation nearer the origination point; and
re-arranging the first selectable target to a presentation less near the origination point than the second selectable target.

12. The method of claim 9, further including a second selectable target and a third selectable target, the method including:
re-arranging a second selectable target less likely to be selected first, to a presentation nearer the origination point; and
re-arranging a third selectable target less likely to be selected second, to a presentation nearer the origination point, but wherein the second selectable target is re-arranged to a presentation nearer the origination point than the third selectable target.

13. The method of claim 9, wherein re-arranging the first selectable target more likely to be selected first to a presentation nearer the origination point, includes the compiling a list of visited data-access locations;
identifying data-access locations that are visited more than once;
presenting the visited data-access locations as a navigational control record including selectable target.

14. The method of claim 9, wherein re-arranging the first selectable target includes retaining the presentation, but selecting the first selectable target with a generic user command.

15. The method of claim 9, wherein the computational machine is a second computational machine, and wherein re-arranging the first selectable target is derived from instructions for a first computational machine, wherein in the first computational machine, the first selectable target is originally presented nearer an origination point.

16. The method of claim 9, wherein re-arranging the first selectable target is carried out in a spatial relationship to the origination point for a visual presentation.

17. The method of claim 9, wherein re-arranging the first selectable target is carried out in a auditory relationship to the origination point for an audio presentation.

18. The method of claim 9, wherein re-arranging the first selectable target is carried out in a tactile-sequential relationship to the origination point for a haptic presentation. wherein presenting the navigational control record is done by presenting a most recently visited data-access location as a prominent selectable target.

19. A machine-readable medium embodying instructions that, when executed by a machine, cause the machine to:
in a computational machine presentation for a first hardware context including an origination point for a user, re-arranging a first selectable target more likely to be selected first, to a presentation nearer the origination point.

20. The machine-readable medium of claim 19, wherein the instructions when executed by a subsequent machine, cause the computational machine presentation to include the origination point for the user, and to present the first selectable target similarly as in the first hardware context.

21. The machine-readable medium of claim 19, wherein the instructions when executed by a subsequent machine, are executed as a subsequent computational machine presentation that includes a subsequent hardware context.

22. The machine-readable medium of claim 19, wherein the instructions when executed by a subsequent machine, including in a subsequent hardware context and including the origination point for the user, present to a subsequent user, the first selectable target differently as in the first hardware context.

23. A computing system comprising:
memory having a repository with a set of instructions that, when executed, cause a computing machine to:
in a computational machine presentation for a first hardware context including an origination point for a user, re-arranging a first selectable target more likely to be selected first, to a presentation nearer the origination point; and
in a subsequent hardware context, emulating the computational machine presentation from the first hardware context.

24. The computing system of claim 23, wherein the instructions when executed in a subsequent hardware context, cause the computational machine presentation to include the origination point for the user, and to present the first selectable target similarly as in the first hardware context.

25. The computing system of claim 23, wherein the hardware context is selected from a mobile machine, a desktop machine, and a laptop machine.

26. The computing system of claim 23, wherein the computational machine presentation is selected from a graphical user interface, an audio user interface, a tactile/motile user interface, and combinations thereof.
